(19) United States
(12) Patent Application Publication
(10) Pub. No.: US 2012/0167827 A1
(43) Pub. Date: Jul. 5, 2012

(54) Combination Pet Food Tray and Activity Device

(76) Inventor: Isabelle Rochon, St-Augustin-de-Desmaures (CA)

(21) Appl. No.: 13/389,500

(22) PCT Filed: Sep. 20, 2010
(86) PCT No.: PCT/CA10/01461

§ 371 Date: Feb. 8, 2012

(30) Foreign Application Priority Data
Sep. 21, 2009 (GB) 0916555.6

(51) Int. Cl. A01K 5/00; A01K 29/00

(52) U.S. Cl. 119/51.01

(57) ABSTRACT

A combination pet food tray and activity device has a plurality of columns removably or fixedly attached to a base. Each column having a top opening into which a pet insert its paw to take the food in the columns. In a preferred embodiment, some of the columns comprise at least one aperture. The length of some of the columns is preferably of different length.

### CROSS-REFERENCE TO RELATED APPLICATIONS

The present patent application claims the benefits of priority of commonly assigned Patent Application No. GB0916555.6, entitled “Combination cat food tray and activity device” and filed at the United Kingdom Intellectual Property Office on Sep. 21, 2009.

### FIELD OF THE INVENTION

The present invention relates generally to pet toys but more particularly to a combination of a pet activity device and food tray.

### BACKGROUND OF THE INVENTION

There are many types of pet serving trays. Some such food trays also include some form of stimulating activity for the pet.

### SUMMARY OF THE INVENTION

The present invention is generally providing a combination pet food tray and activity device comprising a base; and a plurality of columns attached to the base, wherein the columns comprises a top opening.

The columns may be removably or fixedly attached to the base. In a preferred embodiment, at least one of the columns comprises an aperture. The columns may have varying length.

In a preferred embodiment, the internal surface or a portion of the internal surface of a column is textured.

A cover may be connected to the top portion of the column to increase the level of difficulty to reach the food in the column. Also, at least one of the columns may comprise a false bottom.

In a preferred embodiment, at least one of the columns is formed by a plurality of stackable elements. The elements comprise a top portion and a bottom portion and these portions are adapted to be removably attached. The elements may have varying length. A false bottom may be installed between two adjacent elements.

In a further embodiment, the present invention is generally providing a combination pet food tray and activity method, the method comprising the step of disposing a base; attaching a plurality of columns on said base, said columns comprising a top opening; and disposing food in at least one of said columns through said top opening. The columns may be formed by stacking a plurality of elements to form columns having different length.

It is a main advantage of this invention to provide for a stimulating source of activity for a pet while being used as a food tray. Creating a challenging activity for pets, more particularly cats, can be beneficial for the pet's mental health.

In an embodiment where the columns are removably connected to the base, it is possible to change the configuration of the food tray to provide a new challenge to the pet. The height of the columns may be modified by combining different elements together.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of the invention.

FIG. 2 is side view of the invention.

FIG. 3 is top view of the invention.

FIG. 4 is a perspective view of a column comprising a cover.

FIG. 5 is a perspective view of a column having a square shape.

FIG. 6 is a perspective view of a column having a curved profile.

FIG. 7 is a perspective view of a column having a curved profile.

FIG. 8 is a perspective view of a column having a cover and a curved profile.

FIG. 9 is a perspective view of a column having a false bottom and a textured internal surface.

FIG. 10 is a cross-section view of a column composed by two elements and having a false bottom.

### DETAILED DESCRIPTION OF THE PREFERRED EMBODIMENT

A novel combination pet food tray and activity device will be described hereinafter. Although the invention is described in terms of specific illustrative embodiment(s), it is to be understood that the embodiment(s) described herein are by way of example only and that the scope of the invention is not intended to be limited thereby.

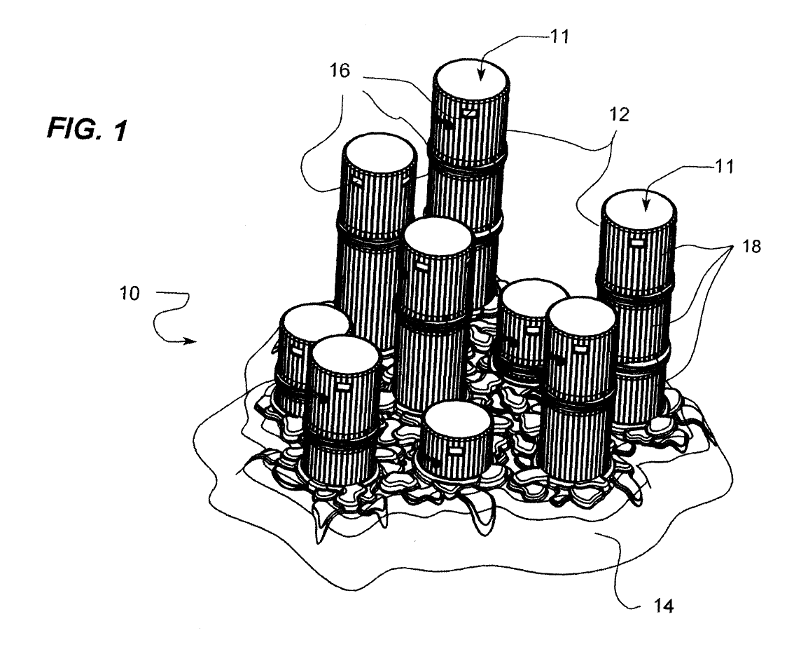

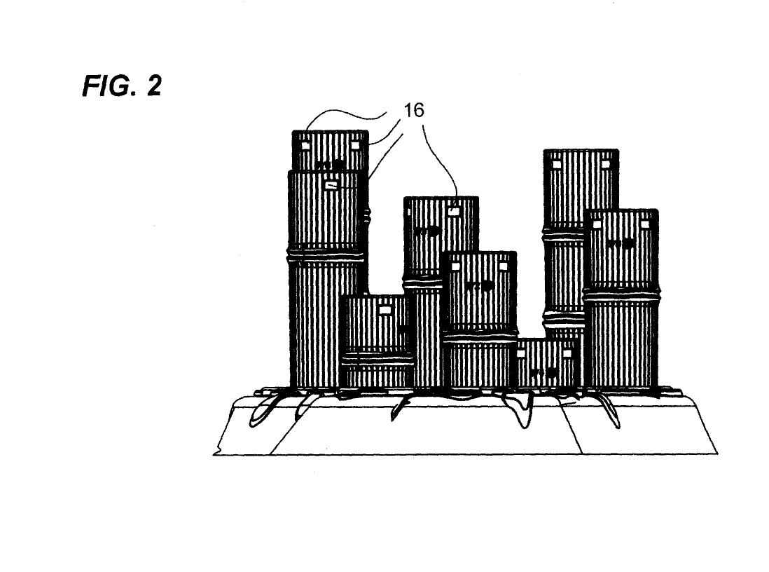

A combination pet food tray and activity device 10 has a plurality of columns 12 set over a base 14. The columns 12 have different lengths and are removably attached to the base 14 so that they can be switched around so as to create variety for the pet. It can be seen in FIGS. 1 and 2 that some of the columns 12 have one or more apertures 16.

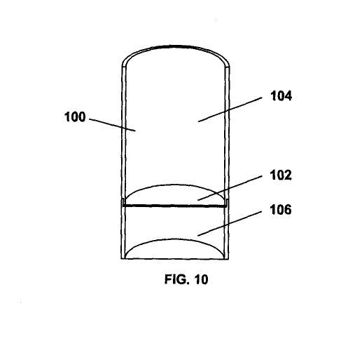

In a preferred embodiment, a column 12 may be formed by a plurality of elements 18. As illustrated in FIGS. 1, 2 and 10, the elements 18 may have different length. The length of a column 12 depends of the number of elements 18 forming it and of the length of each of the elements 18. It can be seen in FIGS. 1 and 2 that the elements 18 may be stacked one above the other. To removably attach the elements to each other, the bottom portion of an element is adapted to be removably attached to the base or to the top portion of another element 18. For example, the bottom portion of an element can be screwed on the top portion of another element. The different elements could also be clipped, or connected with attaching means such as clamp, or other means known in the art. In a still preferred embodiment, the invention may be sold already assembled to form column already assembled and not dismountable. FIG. 10 shows a cross-section view of a column 100 composed by two elements 104 and 106 that are screwed together. A false bottom 102 is installed between the two elements 104 and 106 to modify the internal depth of the columns.

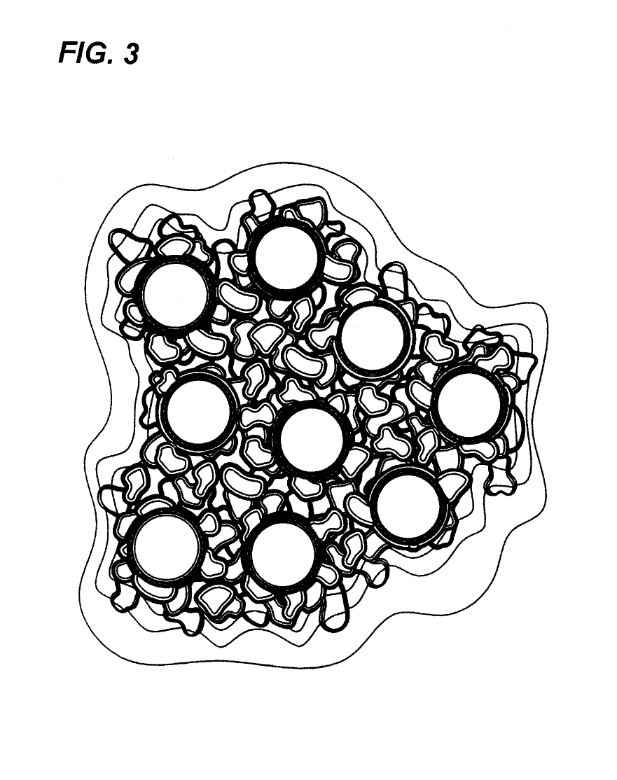

In the embodiment shown in FIGS. 1 to 3, the elements have the same cross section but it is to be understood that there could be a plurality of element or column shapes. For example, in a still preferred embodiment, the invention could comprise one column having a square cross-section and a column having a triangular cross-section. The base in consequently adapted to received the different shapes. The columns may be screwed, clipped, press-fitted or otherwise connected to the base, as known in the art. In a further embodiment, the columns or elements may be inserted into openings in the base and the base sits on an enlarged bottom portion, for example, of the columns or elements. Also, the profile of a column is not necessarily continuous, for example, in a preferred embodiment, a column may have a conical shape and still be composed by a plurality of elements.

The pet, for example a cat, is allowed to enact a behavior similar by having the pet hunt for its food. Firstly, the pet has to smell to detect which column(s) 12 and/or element(s) 18 contains food. There is then the simulated capture of a prey by inserting its paw through the top opening 11 and pushing the food through the aperture 16, or through the opening 11. It is also possible to place pet toys in the columns.

Once the food bits have passed through the aperture 16, it falls in between the various columns 12 which increases the level of difficulty and thus challenges the pet. The texture of the base 14 helps in trapping the food between the columns 12 by reducing roll offs.

It is to be noted that, in a further embodiment, the columns may be fixedly attached to the base.

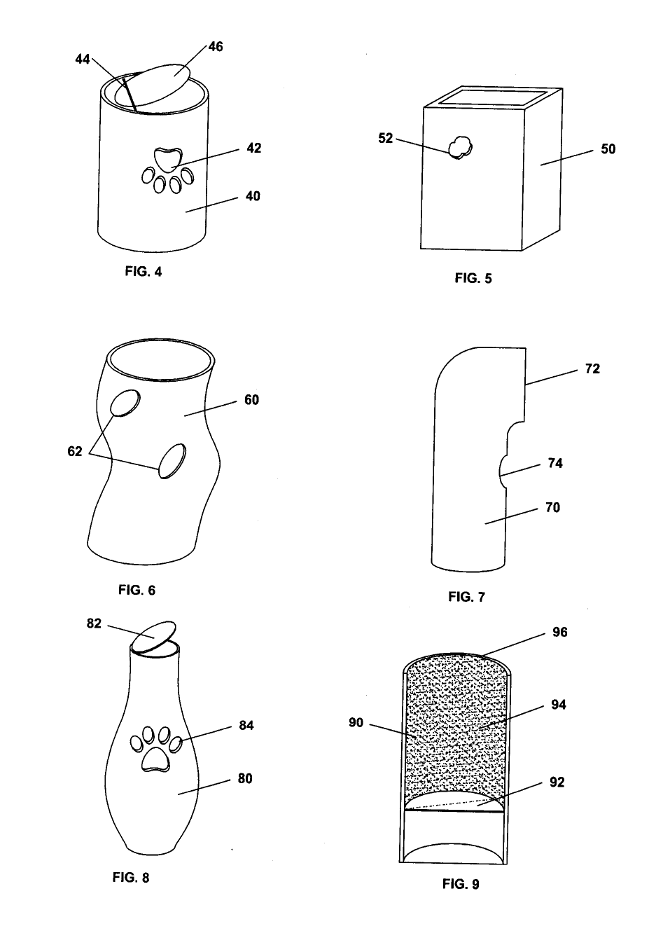

FIGS. 4 to 9 show other embodiments of the present invention. FIG. 4 shows a column 40 having a rotating cover 46 connected to a pin 44, and a paw shaped aperture 42. With this embodiment, the animal has to tilt the cover 46 to reach the food.

FIG. 5 shows a column 50 having a squared cross-section and an aperture 52 having a cloud shape.

FIG. 6 shows an embodiment of a column 60 having a curved profile, adding a level of difficulty to reach the food. The embodiment of FIG. 6 comprises two openings 62 having an oval shape.

The column 70 of FIG. 7 comprises a deviation at its top end. The pet can reach the food through the opening 72 and the aperture 74.

FIG. 8 shows column 80 having a cover 82 that needs to be opened by the animal in order for it to reach the food. A spring or a hinge, for example, may be used to connect the cover 82 to the column. It can be seen that the profile of the column 80 is not continuous; the bottom portion and the top portion are smaller than the middle portion. The column 80 portion comprises a paw shaped aperture 80.

The column 90 shown in FIG. 9 comprises a false bottom 92. The internal surface of the column 90 is textured (94) to add a level of difficulty to take the food. In another embodiment, only a portion of the internal surface can be textured. The column 90 does not comprise an aperture and the animal has to bring the food up to the opening 96.

In a preferred embodiment, only some columns comprise an aperture and the pet has to adapt the method to reach the food with each column.

There are many other benefits for the pet such as eating smaller quantities at a time which improves digestion.

Overall, by exercising, a pet is less likely to be bored and depressive.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A combination pet food tray and activity device comprising:
a) a base; and
b) a plurality of columns attached to said base, wherein said columns comprise a top opening.

2) The device of claim 1, wherein said columns are removably attached to said base.

3) The device of claim 1, wherein said columns are fixedly attached to said base.

4) The device of claim 1, wherein at least one of said columns comprises an aperture.

5) The device of claim 1, wherein said columns have varying length.

6) The device of claim 1, wherein said column(s) comprise an internal surface and wherein at least one of said columns comprise at least a portion of said internal surface that is textured.

7) The device of claim 1, wherein said column(s) comprise a top portion and wherein a cover is connected to said top portion of said column.

8) The device of claim 1, wherein at least one of said column(s) comprises a false bottom.

9) The device of claim 1, wherein at least one of said columns are formed by a plurality of stackable elements.

10) The device of claim 9, wherein said elements comprise a top portion and a bottom portion and wherein said bottom portion and said top portion of said elements are adapted to be removably attached.

11) The device of claim 9, wherein said elements have varying length.

12)The device of claim 9, wherein a false bottom is installed between two adjacent elements.

13) A combination pet food tray and activity method, said method comprising the step of:
a) disposing a base;
b) attaching a plurality of columns on said base, said columns comprising a top opening; and
c) disposing food in at least one of said columns through said top opening.

14) The method of claim 13, wherein said columns are formed by stacking a plurality of elements to form columns having different length.

15) The method of claim 13, wherein said columns are removably attached to said base.

16) The method of claim 13, wherein said columns are fixedly attached to said base.
